(19) United States
(12) Patent Application Publication
(10) Pub. No.: US 2022/0343028 A1
(43) Pub. Date: Oct. 27, 2022

(54) APPLICATION PROGRAMMING INTERFACE (API) CALL SECURITY

(71) Applicant: Citrix Systems, Inc., Fort Lauderdale, FL (US)

(72) Inventors: Subramanian Krishnan, Bangalore (IN); Guna Sekhar Pera, Bangalore (IN)

(21) Appl. No.: 17/238,340

(22) Filed: Apr. 23, 2021

(51) Int. Cl. G06F 21/71

(52) U.S. Cl. CPC G06F 21/71

(57) ABSTRACT

A method may include determining, by a computing system, that first access credentials for a first application programming interface (API) call received from a client device are valid. The method may further include initially refraining from processing the first API call, notwithstanding the first access credentials being valid, based at least in part on the computing system determining that the first API call is suspicious. The method may also include sending, from the computing system to the client device and based at least in part on the first API call being suspicious, a request for the client device to establish that the client device is authorized to make the first API call. The method may additionally include receiving, by the computing system and from the client device, a response to the request. Furthermore, the method may include determining, by the computing system, to process the first API call.

### BACKGROUND

Many software applications or websites may employ one or more application programming interfaces (APIs). An API of an application may allow outside communication with the application. For example, another application or system may call the API of the application and request to obtain data, a service, or something else of value. The API may outline how other applications may communicate with the API, such as the types and/or formats of calls or requests that can be made with the API.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may include determining, by a computing system, that first access credentials for a first application programming interface (API) call received from a client device are valid. The method may further include initially refraining from processing the first API call, notwithstanding the first access credentials being valid, based at least in part on the computing system determining that the first API call is suspicious. The method may also include sending, from the computing system to the client device and based at least in part on the first API call being suspicious, a request for the client device to establish that the client device is authorized to make the first API call. The method may additionally include receiving, by the computing system and from the client device, a response to the request. Furthermore, the method may include determining, by the computing system, to process the first API call.

In some disclosed embodiments, a system may include at least one processor and at least one computer-readable medium encoded with instructions which, when executed by the at least one processor, cause the system to determine that first access credentials for a first API call received from a client device are valid. The at least one computer-readable medium may be further encoded with additional instructions which, when executed by the at least one processor, cause the first computing system to initially refrain from processing the first API call, notwithstanding the first access credentials being valid, based at least in part on determining that the first API call is suspicious. The at least one computer-readable medium may also be encoded with additional instructions which, when executed by the at least one processor, cause the first computing system to send, to the client device and based at least in part on the first API call being suspicious, a request for the client device to establish that the client device is authorized to make the first API call. The at least one computer-readable medium may additionally be encoded with additional instructions which, when executed by the at least one processor, cause the first computing system to receive, from the client device, a response to the request. Furthermore, the at least one computer-readable medium may be encoded with additional instructions which, when executed by the at least one processor, cause the first computing system to determine to process the first API call based at least in part on the response indicating that the client device is authorized to make the first API call.

In some disclosed embodiments, a method may include receiving, by a computing system and from a client device, a response to a challenge that an API gateway sent to the client device. The method may further include determining, by the computing system, that at least one component associated with the API gateway determined that a first API call the client device sent to the API gateway is suspicious notwithstanding access credentials for the API call being valid. The method may also include determining, by the computing system, that the response indicates the client device is authorized to make the first API call. The method may additionally include sending, by the computing system to the API gateway, an instruction that causes the API gateway to authorize processing of the first API call.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram showing example components of a first illustrative API call system in accordance with some aspects of the present disclosure;

FIG. 1B is a diagram showing example components of a second illustrative API call system in accordance with some aspects of the present disclosure;

FIG. 2 is a diagram of a network environment in which some components of API call systems disclosed herein may be deployed;

FIG. 3 is a diagram of an example computing system that may be used to implement one or more components of the network environment shown in FIG. 2;

FIG. 4 is a diagram of a cloud computing environment in which various aspects of the disclosure may be implemented;

FIG. 5A shows a first example API call process involving example operations for a client device in accordance with various aspects of the disclosure;

FIG. 5B shows a second example API call process involving example operations for a client device in accordance with various aspects of the disclosure;

FIG. 6 shows an example API call process involving example operations for a computer system in accordance various aspects of the disclosure;

FIG. 7 shows an example API call process involving example operations for an analytics engine in accordance various aspects of the disclosure;

FIG. 8 shows an example API call process involving example operations for a resolver in accordance various aspects of the disclosure;

FIG. 9 shows an example API call process involving example operations in accordance with various aspects of the disclosure;

FIG. 10 shows a sequence diagram illustrating an example workflow involving the example API system shown in FIG. 1A;

FIG. 11 shows a sequence diagram illustrating an example workflow involving the example API security system shown in FIG. 1B; and

FIG. 12 also shows an example API call process involving example operations in accordance various aspects of the disclosure.

### DETAILED DESCRIPTION

For purposes of reading the description of the various embodiments below, the following descriptions of the sections of the specification and their respective contents may be helpful:

Section A provides an introduction to example embodiments of API call systems configured in accordance with some aspects of the present disclosure;

Section B describes a network environment which may be useful for practicing embodiments described herein;

Section C describes a computing system which may be useful for practicing embodiments described herein;

Section D describes a cloud computing environment which may be useful for practicing embodiments described herein;

Section E provides a more detailed description of example embodiments of the API call systems introduced above in Section A; and

Section F describes example implementations of methods, systems/devices, and computer-readable media in accordance with the present disclosure.

### A. Introduction to Illustrative Embodiments of API Call Security Systems

The number of APIs, and web APIs in particular, is constantly increasing and thus leads to constantly increasing API traffic. Some APIs may allow for accessing powerful capabilities or important data. Thus, it may be important to protect APIs so that only legitimate or otherwise authorized clients and/or users can access them.

As discussed above, an API may outline how other applications may communicate with the API, such as the types and/or formats of calls or requests that can be made with the API. A client device or application running on the client device (the “client”) may attempt to invoke a server capability or an application running on a computing system that may include one or more servers (the “server”) using, for example, a web API of the server. The client may be attempting to receive data from the server, send data to the server, invoke an operation of the server, change data on the server, or otherwise leverage one or more capabilities of the server through the API. As such, APIs typically provide something of value (e.g., data or processing capability).

While some APIs may be open or unprotected, many APIs that are deemed to provide a valuable capability are protected by authentication and/or or authorization capabilities. Authentication may refer to verifying an identity of a caller by the API. Authorization may refer to verifying that the caller is permitted to perform certain operations via the API. For example, access credentials such as a username/password, client certificate, access token, key etc., may be required to access the desired capability by calling the API.

API call security may pose challenges and related statistics show that many security breaches involve APIs. When the access credentials are invalid, the API call may be cleanly rejected. For example, the access credentials may be invalid if the API call is made with the wrong username/password, client certificate, access token, key etc. In some circumstances, even API calls with proper access credentials that appear legitimate may, in fact, be illegitimate or malicious. For example, hackers may use valid credentials to try to break into APIs and access data or perform operations for which they are not authorized. The hackers may access or change private user data or may cause underlying applications to make unauthorized transactions (e.g., transfer funds). Despite existing protections, some hackers may be successful in breaching computers via APIs using not just stolen API access credentials, but also by spoofing client locations, IP addresses, MAC addresses, or other contextual information that may be used for API call security.

Protecting against hacking of APIs may include using analytics to detect anomalies in API calls. API security analytics may be used to prevent API security threats and/or automatically detect API attacks in progress based on the detected anomalies. For example, the anomalies may include a client attempting to call an API from a new or different location than previously detected, an API call during a new or different time of day, increased API activity from a client, and/or a call originating from a new device. Further anomalies may include many failed API call attempts followed by a successful API call attempt.

Various mechanisms may be employed to collect analytics on API calls and detect and determine patterns and anomalies, including the use of analytics engines, machine learning models, neural networks, or other artificial intelligence capabilities. Once an anomaly is detected for an API call with valid access credentials, a decision may be made on an action to be taken based on the anomaly and related information or intelligence.

For example, when an anomaly is detected, the server running the API may block or otherwise not respond to the API call. This may be acceptable if the API call with the anomaly is actually illegitimate or malicious, but often API calls with anomalies may be legitimate and authorized. For example, an API call may originate from a location out of the ordinary but still be legitimate and authorized (e.g., the call originates from an authorized user/client device). In those cases, the server may lack knowledge regarding the legitimacy of the API call and may block a legitimate API call, which may cause downtime for the client making the API call and/or seriously impact related business. As a result, an authorized user may be frustrated in their purpose of accessing data on the server as desired. Overall, such all or nothing approaches often lead to poor and unproductive user experiences.

In another example, when an anomaly is detected, the server may generate an alert, flag, or notification based on the anomaly. The alert, flag, or notification may need to be manually processed (e.g., by a human) to determine if it is based on an illegitimate or malicious API call, and there may be few or no decisive ways to make such a determination because the fact of the anomaly itself (e.g., API call from an unrecognized location or at an unusual time) does not necessarily indicate that the API call is unauthorized. The manual processor may have to contact the client making the API call to make such a determination, and this may result in lost time and negative business impact.

Further, when an anomaly is detected, a combination of blocking the API call and generating an alert may be used to protect the server. For example, an alert may be initially generated and if a preconfigured threshold (e.g., number of failed API call attempts) is subsequently breached, the API call may be blocked. This tactic, however, may not fundamentally solve the problem of blocking legitimate API calls or failing to react to illegitimate or malicious API calls because, for example, the API call with the anomaly (e.g., high number of failed API call attempts) may still be legitimate, or illegitimate or malicious API calls may use the high number of failed API call attempts to determine valid access credentials (e.g., a username and password). Thus, such tactics may only change the probability of success in such situations.

Using the techniques and features described in the present disclosure for API call security, various advantages may be realized. For example, the techniques and features described herein may allow for intelligent and dynamic systems and processes to handle API security threats. Further, the techniques and features described herein may allow for automatic resolution of API call anomalies or suspicions in real time or near real time.

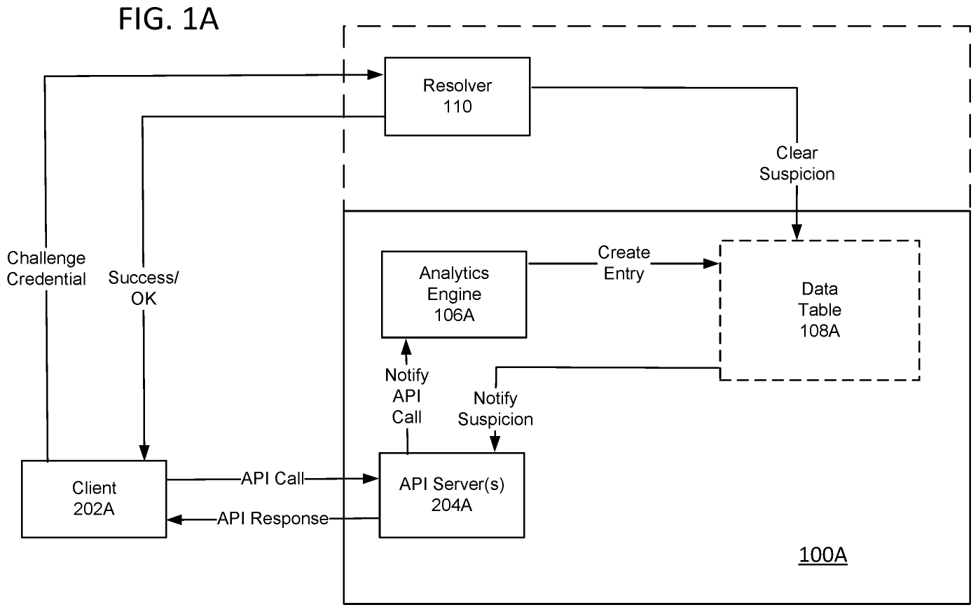

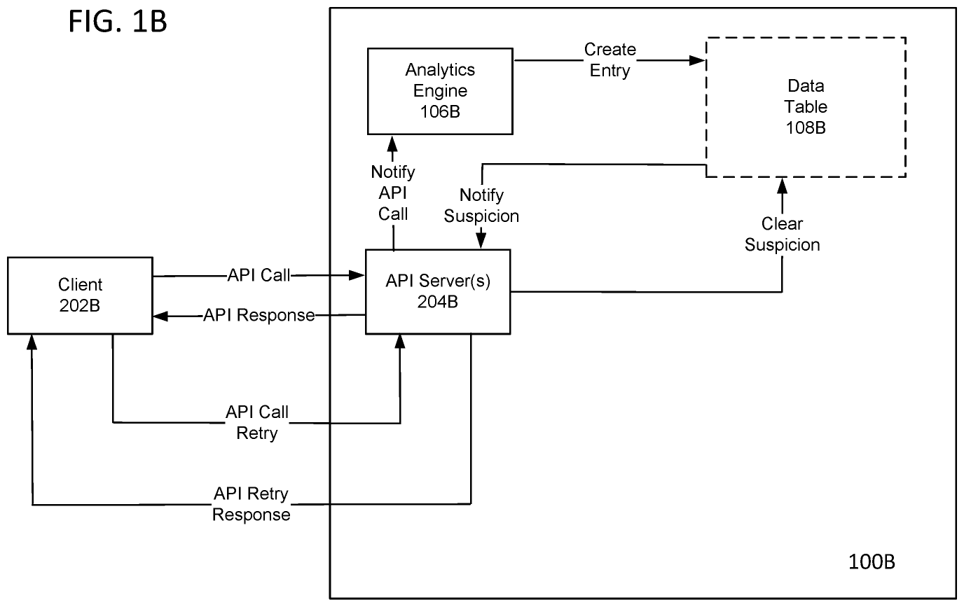

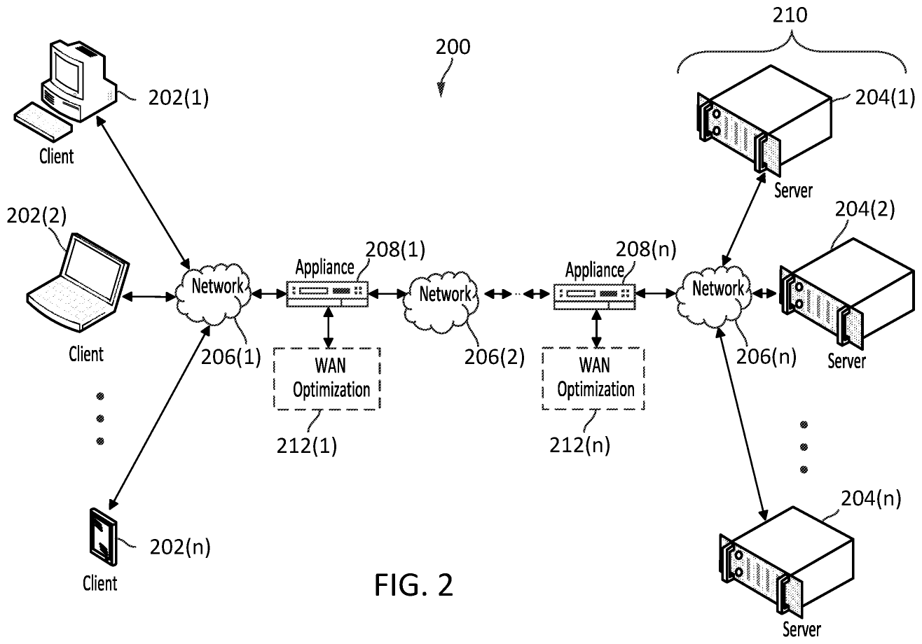

Referring now to FIG. 1A, example components of a first illustrative API call system 100A in accordance with aspects of the present disclosure are shown. As illustrated, the system 100A may include one or more API servers 204A that may receive communications from a client 202A. Examples of client devices 202 and servers 204 that may be used to implement the client 202A and the API server(s) 204A, respectively, are described below in connection with FIGS. 2-4. The client 202A may exist outside the system 100A. The system 100A may further include an analytics engine 106A, a data table 108A, and a resolver 110. The data table 108A may be a suspicion table with entries indicating anomalies with API calls. In some embodiments, the analytics engine 106A, the data table 108A, and/or the resolver 110 may be components running on the API server(s) 204A. Alternatively, in some embodiments, the analytics engine 106, the data table 108A, and/or the resolver 110 may be components running on one or more other servers 204. In the system 100A, the resolver 110 may be at a different uniform resource locator (URL) endpoint than the API server(s) 204A, and for this reason may be referred to as an out-of-band API call system.

As shown in FIG. 1A, the API server(s) 204A may receive an API call from the client 202A and may notify the analytics engine 106A of the API call. The analytics engine 106A may determine whether there is an anomaly with the API call and whether the API call is suspicious. Upon determining that that the API call is suspicious, the analytics engine 106A may create an entry in the data table 108A. The entry may be a record in a cache or table (e.g., data table 108A) which indicates the anomaly with the API call and the context of the anomaly. For example, the entry may indicate information such as a source that was attempted to be accessed via the API call, a hash of credentials attempted to be used to access the source, a reason why the API call is considered to have the anomaly or be suspicious, a timestamp of the API call, a severity of the anomaly, and/or an identifier (ID) (e.g., a unique identifier) for the entry. Thus, the entry may also include a context for the anomaly and/or indicate why the API call is suspicious. The ID for the entry may be used in downstream processing to determine if the API call is legitimate.

Once the API call has been determined to be suspicious or otherwise untrustworthy, the API server(s) 204A may be notified of the suspicion or may determine via the entry for the API call in the data table 108A that the API call is suspicious. The API server(s) 204A may begin resolution of the suspicion or anomaly by sending an API response to the API call (e.g., to the client 202A) indicating that the API call is under suspicion. Further, the API response may include a challenge to the client 202A to resolve the suspicion or anomaly. The challenge may be a request to the client 202A to provide additional credentials. The additional credentials may include a key, certificate, token, question and answer, username and password, etc.

A process for resolving the challenge for an out-of-band API call security system, such as system 100A, may be negotiated between the client 202A and the system 100A (e.g., pre-negotiated when the client 202A registers to use the API). A typical API registration may include providing API resource documentation to the client 202A and credentials for making an API call. In some embodiments in accordance with the present disclosure, when a client registers to use an API with the API server(s) 204A, a suspicion resolution process may be pre-negotiated and additional credentials for suspicion resolution may be provided from the system 100A to the client 202A (or, alternatively, may be determined by the client 202A and shared with the system 100A), for responding to the challenge. The additional credentials, which may be referred to as the challenge credentials, may include data such as a key, certificate, token, question and answer, username and password, etc., that the client 202A may provide in response to the challenge. In some implementations, multiple pre-negotiated responses to challenges may be determined during the registration, and the API server(s) 204A may indicate which response(s) are to be used to resolve a particular challenge. Thus, a legitimate client will be able to respond to a challenge when under suspicion because the client is in possession of an acceptable, pre-negotiated response to the challenge.

For an out-of-band API call security system (e.g., system 100A), the suspicion resolution process for resolving the challenge may include calling a resolution endpoint. The resolution endpoint may be called using a reference or identifier such as a uniform resource identifier (URI) or URL that is different than a reference, identifier, or endpoint URL addressed in the API call. The resolution endpoint may be the resolver 110, which may run on a different server than the API server(s) 204A. The API response sent from the API server(s) 204A to the client 202A may include a URL for the resolution endpoint (e.g., the resolver 110), the ID for the API call, and the challenge credentials. The suspicion resolution process may include the client 202A passing challenge credentials (or an indication thereof such as an encrypted value) to the resolver 110 (e.g., by making a separate API call to the resolver 110). The resolver 110 may use the challenge credentials provided by the client 202A to resolve the challenge or otherwise address the concerns with that entry from the data table 108A, and notify the client 202A that the suspicion resolution has been successful or that the suspicion no longer remains and that the API call can be made again without being challenged.

Referring now to FIG. 1B, example components of a second illustrative API call system 100B in accordance with aspects of the present disclosure are shown. As illustrated, the system 100B may include one or more API server(s) 204B that may receive communications from a client 202B, which may be outside the system 100B. Examples of client devices 202 and servers 204 that may be used to implement the client 202B and the API server(s) 204B, respectively, are described below in connection with FIGS. 2-4. The system 100B may further include an analytics engine 106B and a data table 108B. In some embodiments, the analytics engine 106B and/or the data table 108B may be components running on the API server(s) 204B. Alternatively, in some embodiments, the analytics engine 106B and/or the data table 108B may be components running on one or more different servers 204. In the system 100B, rather than having a resolver (e.g., the resolver 110 shown in FIG. 1A) at a separate resolution endpoint or URL endpoint to receive responses to challenges posed by the API server(s) 204B, responses to such challenges may instead be sent to the same the resolution endpoint or URL endpoint as the API server(s) 204B. As such, the system 100B may be referred to as an in-band API call system.

100441 As shown in FIG. 1B, the API server(s) 204B may receive an API call from the client 202B and may notify the analytics engine 106B of the API call. The analytics engine 106B may determine whether there is an anomaly or security concern with the API call and whether the API call is suspicious. Upon determining that the API call is suspicious or includes an anomaly, the analytics engine 106B may create an entry in the data table 108B. Similar to system 100A, the entry in system 100B may be a record in a cache or table (e.g., data table 108A) which indicates the anomaly or other security concern with the API call and/or the context of the anomaly. For example, the entry may indicate information such as a source that was attempted to be accessed via the API call, a hash of credentials attempted to be used to access the source, a reason why the API call is considered to have the anomaly or be suspicious, a timestamp of the API call, a severity of the anomaly, and/or an identifier (e.g., unique identifier (ID)) for the suspicion entry. Thus, the entry may include a context for the anomaly and indicate why the API call is suspicious. The ID for the entry may be used in downstream processing to determine if the API call is legitimate or otherwise authorized.

Once the API call has been determined to be suspicious or otherwise including an anomaly, the API server(s) 204B may be notified of the suspicion or may determine via the entry for the API call in the data table 108B that the API call is suspicious. The API server(s) 204B may begin resolution of the suspicion by sending an API response to the API call (e.g., to the client 202B) indicating that the API call is under suspicion. Further, the API response may include a challenge to the client 202B to resolve the suspicion or otherwise address the anomaly.

A process for resolving the challenge for an in-band API call system, such as system 100B, may be negotiated between the client 202B and the API server(s) 204B (e.g., pre-negotiated when the client 202B registers to use the API). A typical API registration may include providing API resource documentation to the client 202B and credentials for making an API call. In some embodiments in accordance with the present disclosure, when a client registers to use an API with the API server(s) 204B, a suspicion resolution process may be pre-negotiated and additional credentials for suspicion resolution may be provided from the system 100B to the client 202B (or, alternatively, may be determined by the client 202B and shared with the system 100B) for responding to the challenge. The additional credentials, which may be referred to as the challenge credentials, may include data such as a key, certificate, token, question and answer, username and password, etc., that the client 202B may provide in response to the challenge. In some implementations, multiple pre-negotiated responses to challenges may be determined during the registration, and the server 204B may indicate which response(s) are to be used to resolve a particular challenge. Thus, a legitimate client will be able to respond to a challenge when under suspicion because the client is in possession of an acceptable response to the challenge.

As noted above, for an in-band API call system (e.g., system 100B), the suspicion resolution process for resolving the challenge may not include calling a separate resolution endpoint such as the resolver 110. Instead, the API response sent by the API server(s) 204B to the client 202B may include (e.g., in a header of the API response) the challenge to the client 202B to resolve the suspicion or otherwise reconcile the anomaly. The client 202B may answer the challenge (which is known in some examples because it was pre-negotiated) by making the API call again (e.g., the API call retry) with the original access credentials and an additional header (e.g., in the API call retry) that includes the challenge credentials (e.g., the answer to the question/request posed, or an indication thereof such as an encrypted value). The challenge credentials (or indication thereof), which may be, for example, an encrypted value of text, may be passed with the additional header in the API call retry from the client 202B to the API server(s) 204B. The API server(s) 204B may use the API call retry, which includes the challenge credentials (or indication thereof), to resolve the challenge, clear the suspicion entry from the data table 108B, and allow the API call retry to be processed without being challenged.

For both out-of-band (e.g., system 100A) and in-band (e.g., system 100B) API call security systems, an illegitimate client (e.g., controlled by a hacker or other bad actor) will be unlikely to resolve the challenge because the illegitimate client would not have possession of challenge credentials, e.g., as determined during the registration, despite having somehow maliciously obtained original access credentials of a legitimate client. If the challenge is not responded to within a period of time (e.g., preconfigured timeframe) or a response to the challenge does not include the challenge credentials, the suspicion of the API call may be considered true, and the original access credentials may be invalidated. Subsequent calls to the API server(s) 204A, 204B attempting to access the API with the original access credentials (e.g., even by a legitimate client) may be blocked until new access credentials are issued to the legitimate client.

In this regard, the inventors have recognized and appreciated that even though original access credentials provided with the API call may appear to be from a legitimate client, the original access credentials may have been compromised and anomalies identified with the API call may indicate (but not necessarily confirm) that the API call is from an illegitimate client. Further, the inventors have recognized and appreciated that even when an API call with proper access credentials is identified as illegitimate due to such anomalies, outright rejection of the API call without further investigation and/or flagging of the API call may cause problems (e.g., business downtime) for a legitimate client making the API call, as the anomalies may be benign. Additionally, the inventors have recognized and appreciated that legitimacy of the client making the API call in such situations can be determined by additional challenge credentials, creating a data table or otherwise recording the anomalies, and allowing the client to overcome a suspicion/challenge by providing the challenge credentials through a suspicion resolution process (e.g., provide the challenge credentials to the resolver or retrying the API call with the challenge credentials in an additional header).

Additional details and example implementations of embodiments of the present disclosure are set forth below in Section E, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over interne protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WANTM or Citrix C1oudTM. For example, in some implementations, one or more of the appliances 208, 212 may be cloud connectors that enable communications to be exchanged between resources within a cloud computing environment and resources outside such an environment, e.g., resources hosted within a data center of+an organization.

### C. Computing Environment

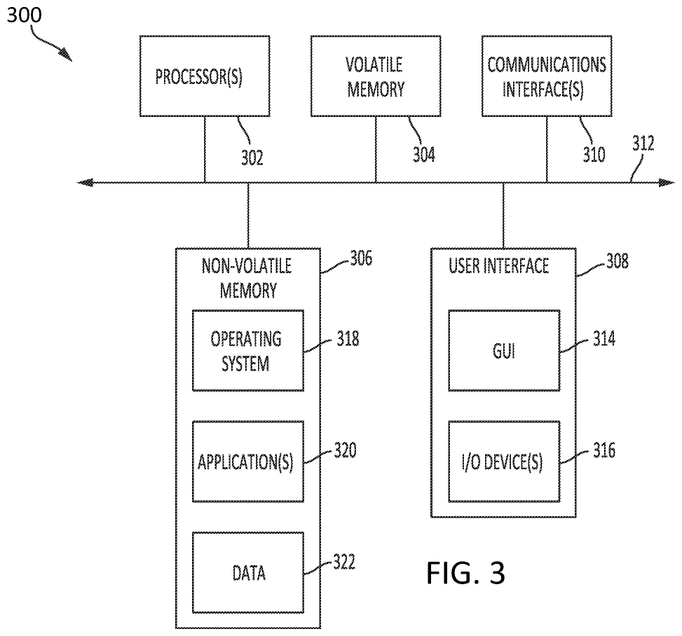

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Cloud Computing Environment

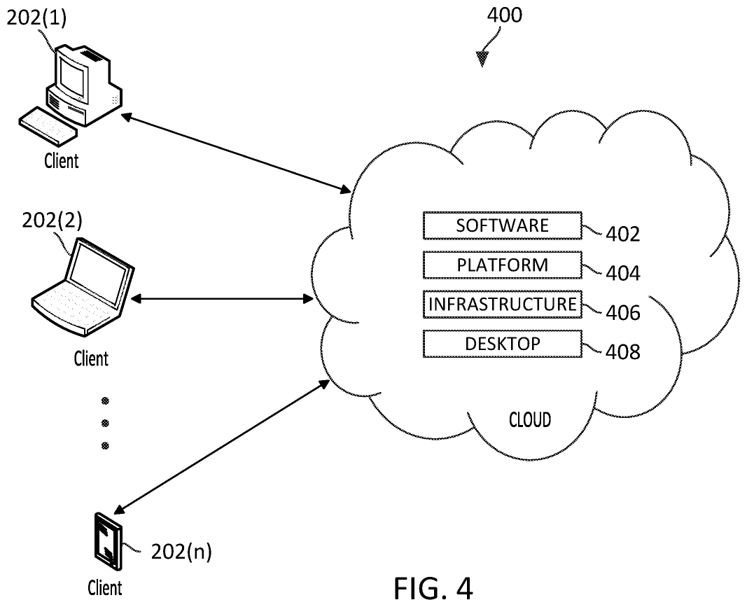

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Detailed Description of Example Embodiments of API Call Systems

As discussed above in Section A, API call systems in accordance with the present disclosure may provide several advantages. The techniques and features of the present disclosure will be described below in the context of identifying suspicions or anomalies with API calls and resolving the suspicions so that the API calls can be processed for legitimate clients. As described in connection with FIGS. 1A and 1B, for example, an analytics engine 106A, 106B may determine whether there is an anomaly with an API call and whether the API call is suspicious. The analytics engine 106A, 106B may create an entry in a data table 108A, 108B which may include a context for the anomaly and indicate why the API call is suspicious. Resolution of the suspicion/anomaly may include sending an API response to the API call indicating that the API call is under suspicion and including a challenge to resolve the suspicion or anomaly. A response to the challenge, e.g., determined during the API registration process, may allow a legitimate client overcome the challenge.

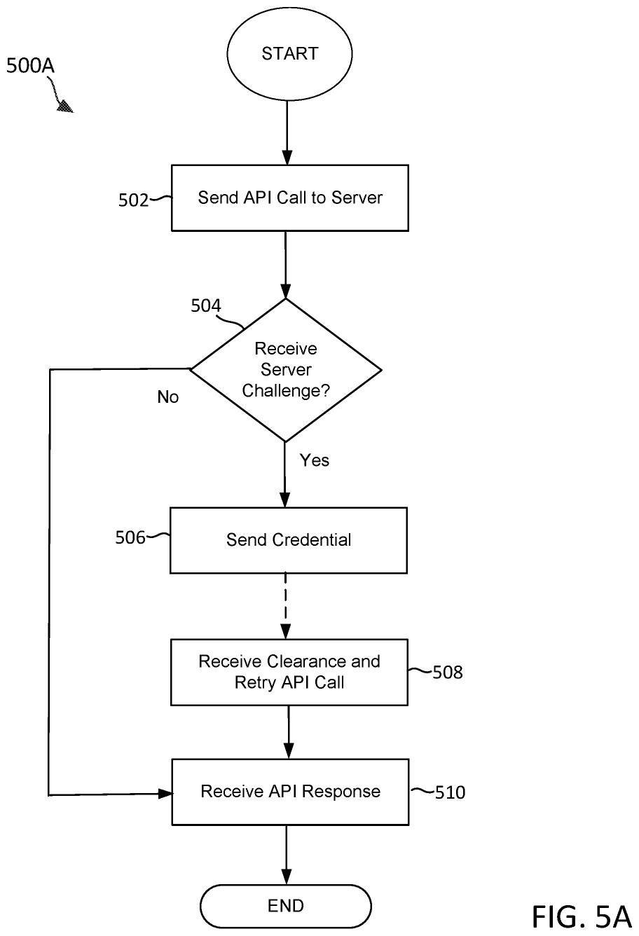

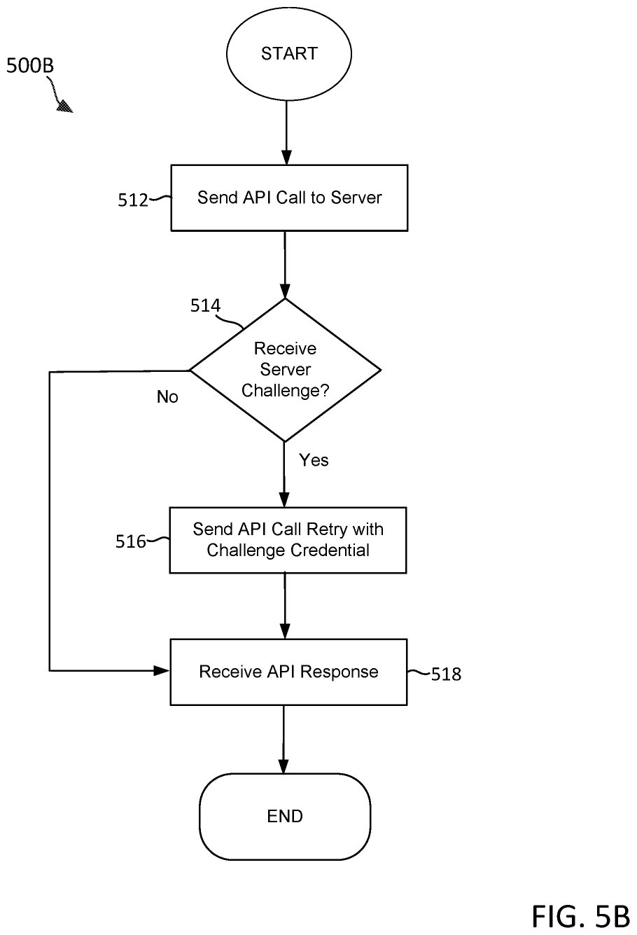

Various components of the systems 100A and 100B may perform operations to facilitate suspicion resolution in API calls. Such operations may, for example, be performed by one or more processors that execute instructions encoded on one or more computer-readable media. Referring now to FIG. 5A, an example routine 500A that may be performed by the client 202A in the out-of-band API call system 100A (shown in FIG. 1A) is illustrated. As shown in FIG. 5A, the client 202A may send (502) an API call to the API server(s) 204A. If the client 202A does not receive (504) a challenge (e.g., due to suspicion) from the API server(s) 204A, the API call may be processed based on the original access credential. If the client 202A does receive (504) a challenge (e.g., due to suspicion) from the API server(s) 204A, the client 202A may send (506) a challenge credential (e.g., as pre-negotiated during registration of the client 202A with the API server(s) 204A) to the resolver 110. The challenge credential may be validated by the resolver 110, and, in some embodiments, the client 202A may receive (508) clearance from the suspicion from the resolver 110 and retry the API call that prompted the challenge. The client 202A may receive (510) an API response indicating that the API call retry has been successfully processed by the API server(s) 204A.

Referring now to FIG. 5B, an example routine 500B that may be performed by the client 202B in the in-band API call security system 100B (shown in FIG. 1B) is illustrated. As shown in FIG. 5B, the client 202B may send (512) an API call to the API server(s) 204B. If the client 202B does not receive (514) a challenge (e.g., due to suspicion) from the API server(s) 204B, the API call may be processed based on the original access credential. If the client 202B does receive (514) a challenge (e.g., due to suspicion) from the API server(s) 204B, the client 202B may send (516) to the API server(s) 204B an API call retry that includes a challenge credential (e.g., as pre-negotiated during registration of the client with the API server(s) 204A). The challenge credential may be validated by the API server(s) 204B, thus allowing the API server(s) 204B to process the API call retry. The client 202B may receive (518) an API response indicated that the API call retry has been successfully processed by the API server(s) 204B.

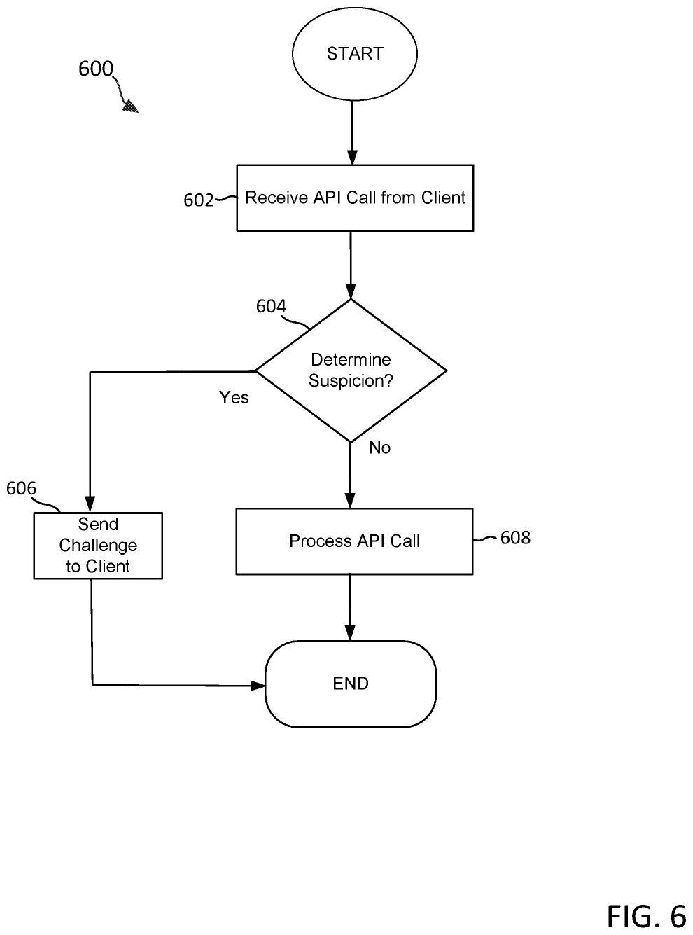

FIG. 6 shows an example routine 600 that may be performed by a computing device (e.g., an API server, such as the API server(s) 204A shown in FIG. 1A or the API server(s) 204B shown in FIG. 1B) in accordance with some embodiments of the present disclosure. As shown, in some implementations, the API server may receive (602) an API call from a client (e.g., the client 202A or 202B). In some implementations, the API server may notify an analytics engine (e.g., the analytics engine 106A or 106B) of the API call. If the API server determines (604) that the API call is suspicious (e.g., by notification from the analytics engine or analyzing the data table), the API server may send (606) a challenge to the client. If the API server does not determine (604) that the API call is suspicious, the server may process (608) the API call.

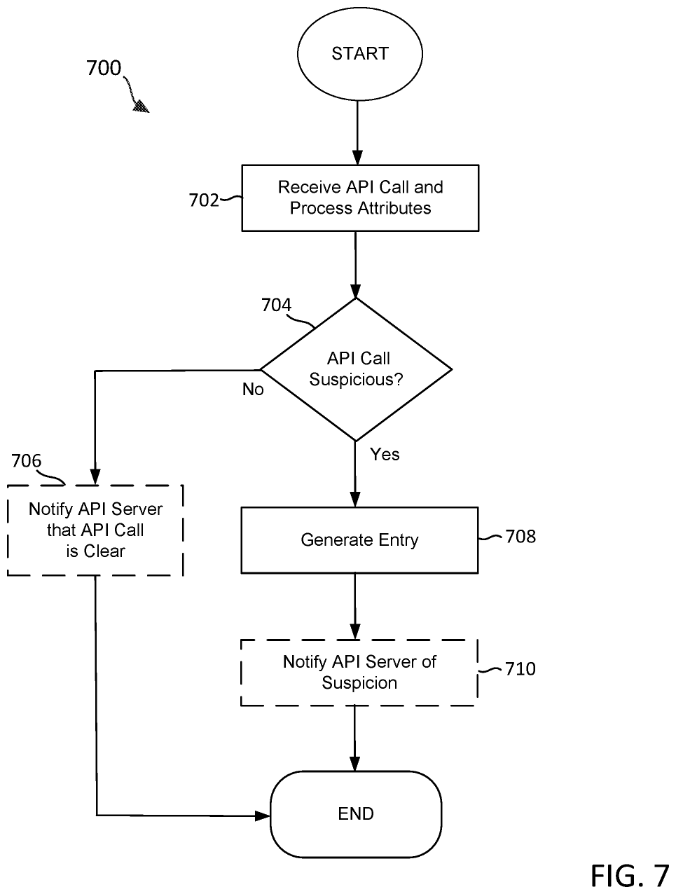

FIG. 7 shows an example routine 700 that may be performed by computing device (e.g., a server computer) that includes an analytics engine (e.g., the analytics engine 106A shown in FIG. 1A or the analytics engine 106B shown in FIG. 1B) in accordance with some embodiments of the present disclosure. As shown, the computing device may receive (702) an API call and process attributes of the API call (e.g., location, time, etc.) from an API server (e.g., the API server(s) 204A shown in FIG. 1A or the API server(s) 204B shown in FIG. 1B). If the computing device determines with use of the analytics engine (704) that the API call is not suspicious, it may notify (706) an API server that the API call is clear to be processed. If, on the other hand, the computing device with use of the analytics engine determines (704) that the API call is suspicious, the computing device may generate (708) an entry in a data table (e.g., the data table 108A shown in FIG. 1A or the data table 108B shown in FIG. 1B) such that subsequent API calls providing the original access credential are blocked. Additionally, the computing device may notify (710) the API server that the API call is suspicious.

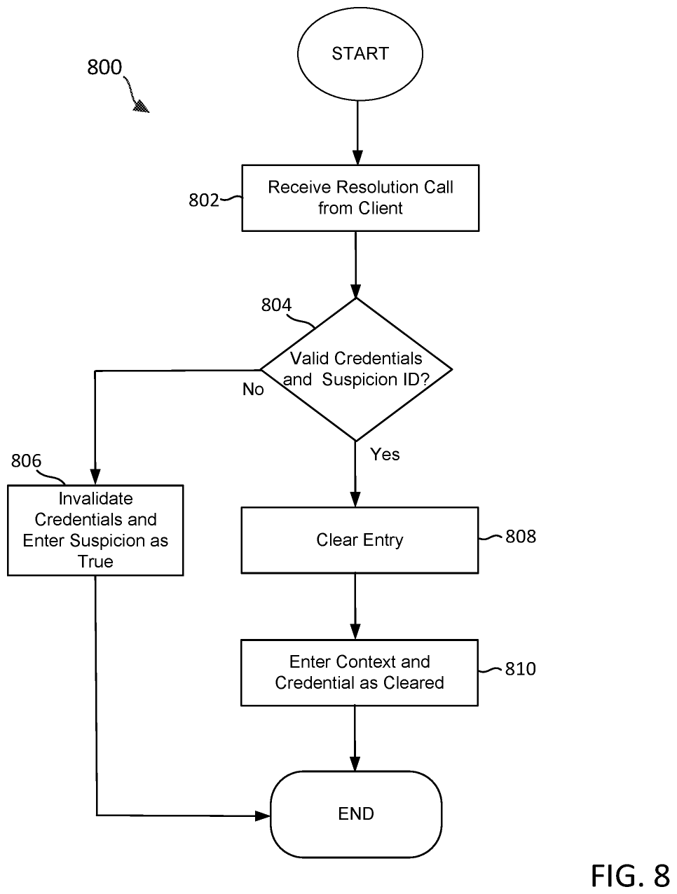

FIG. 8 shows an example routine 800 that may be performed by a computing device (e.g., a server computer) that includes a resolver (e.g., the resolver 110 shown in FIG. 1A) in accordance with some embodiments of the present disclosure. As shown, the computing device may receive (802) a resolution call from a client (e.g., the client 202A shown in FIG. 1A) to resolve a challenge of an API call. The computing device, with use of the resolver, may determine (804) that the API call does not include a valid challenge credential and/or suspicion ID. For example, the computing device may determine that a key, certificate, token, question and answer, username and password, etc., submitted with the API call does not correspond to a challenge credential provided to the client (e.g., during registration with the API server(s)) making the API call, or that the suspicion ID does not match a suspicion ID in a data table corresponding to this API call. Upon making such a determination, the computing device may also invalidate (806) the original access credential and enter (e.g., in the data table 108A shown in FIG. 1A) the suspicion as true such that subsequent API calls with the original access credential are blocked. For example, a hash of the original access credential may be marked as invalid in the data table (e.g., data table 108A or 108B) such that if a subsequent API call is received with the original access credential (even without suspicion), the hash may be used to determine that the original access credential was previously compromised and subsequent API calls using that credential are to be blocked.

If, on the other hand, the computing device with use of the resolver determines (804) that the resolution call does include a valid challenge credential and/or ID, it may clear (808) the data entry indicative of suspicion from within the data table for the API call. The computing device with use of the resolver may also enter (810) a context of the API call and indicate within the data table that the original access credentials are cleared of suspicion such that subsequent API calls with the same context and original access credentials may be processed without being blocked. In some implementations, to protect the privacy and/or security of original access credentials (e.g., user names and passwords), rather than storing the original access credentials in the data table, the data table may instead store hashes of the original access credentials, and such hash values can be used to indirectly identify the corresponding original access credentials.

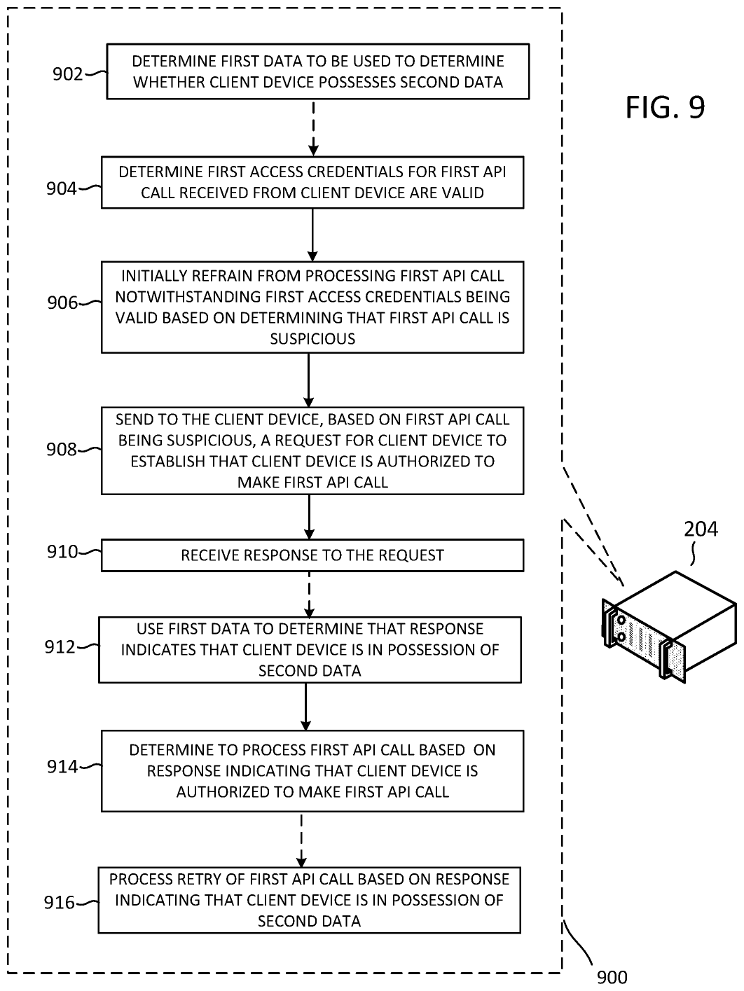

FIG. 9 shows an example routine 900 that may be performed by one or more computing devices (e.g., servers 204 of a computing system, such as the system 100A shown in FIG. 1A or the system 100B shown in FIG. 1B), in accordance some aspects of the present disclosure. As shown, in some implementations, the routine 900 may include determining (902), by the server(s) 204, first data that is to be used to determine whether a client device (e.g., the client 202A shown in FIG. 1A or the client 202B shown in FIG. 1B) possesses second data. For example, the first data may be used by the server(s) 204 to determine whether the client device possesses the second data based on whether a key, certificate, token, question and answer, username and password, etc., issued to the client device (e.g., during registration of the client device with the API server) corresponds to a challenge credential provided by the client device with the API call.

In some embodiments, the second data may be one or more challenge credentials that may or may not be sent to the client by the server(s). For example, in some embodiments, the client device may send the server(s) 204 a public key corresponding to the client's private key. In such embodiments, the server(s) 204 need not send the client the challenge credential data during the API registration process. In such cases, the first data (e.g., the public key) and the second data (e.g., the private key) may be different but related.

Further, in some embodiments, the first and second data may be symmetric keys such as answers, formulas used to generate answers, or authentication credentials for a resolver (e.g., the resolver 110). The first data may be a key, certificate, token, question and answer, username and password, etc. The second data may be the same key, certificate, token, question and answer, username and password, etc., as the first data or, as discussed above, may be a different key, certificate, token, question and answer, username and password, etc., related to the first data. In such embodiments, the server(s) 204 may send the challenge credential data (e.g., the second data) to the client.

The server(s) 204 may further determine (904) that first access credentials for a first API call received from the client device (e.g., the client 202A or 202B) are valid. The first access credentials may be the original access credentials provided by the API server(s) to the client device during registration. The server(s) 204 may also determine that a first API call received from the client device is suspicious. Determining that the API call is suspicious may be based on a number of factors including, but not limited to, a new or different location or geography than previously detected (e.g., in association with the credentials presented), a new or different time of day than previously detected (e.g., in association with the credentials presented), increased API activity from the client device, the API call originating from a new device, and/or a number of failed API call attempts followed by a successful API call attempt. It should be noted that the factors listed above used to determine whether an API call is suspicious are provided for illustrative purposes only and other factors such as factors determined by an analytics engine (e.g., the analytics engine 106A or 106B) may also be used. For example, a history of suspicious API calls and resolutions may inform different or additional factors that may be used by the analytics engine to determine suspicious API calls.

In some embodiments, the servers 204 may store third data based on the first API call received from the client device (e.g., the client 202A or 202B). The third data may include one or more of a source that was attempted to be accessed via the API call (e.g., an API context), a hash of credentials attempted to be used to access the source (e.g., a credential hash), a reason why the API call is considered to have the anomaly or be suspicious (e.g., a reason tag), a timestamp of the API call, a severity of the anomaly, and/or a unique ID such as a suspicion ID for the suspicion entry. The third data may be stored in a data table (e.g., the data table 108A shown in FIG. 1A or the data table 108B shown in FIG. 1B) which may resemble Table 1 below:

TABLE 1

| API Context | Credential Hash | Suspicion ID | Reason Tag | Severity |
|---|---|---|---|---|
| Fool Service:/ | DC80BDCD5D2 | bb82641f-dd1b- | Origin geo | 1 |
| bar1/resource | 2358524 | 4da3-9582 | | |
| | | 1761ec4408e4 | | |
| Foo2Service:/ | 7D69223842941 | 0a53bddb-a24f- | Unexpected | 2 |
| bar2/resource | 96B9233 | 4a60-a052 | time | |
| | | 587a59da3997 | | |

The data table may, for example, be generated and/or stored by the API server(s) (e.g., the API server(s) 204A or 204B), the analytics engine (e.g., the analytics engine 106A or 106B), or the resolver (e.g., the resolver 110). The API server(s), the analytics engine, or the resolver may also enter and change data in the data table. As indicated in Table 1, the client may have attempted a legitimate API call from a different geographic location (e.g., Reason tag: “Origin geo”), which may be detected as suspicious by, for example the analytics engine.

The server(s) 204 (e.g., the API server(s) 204A or 204B) may initially refrain (906) from processing the first API call, notwithstanding the first access credentials being valid, based on the server(s) 204 determining that the first API call is suspicious. In some embodiments, the server(s) 204 may refrain from processing the first API call at all and may process a retry of the first API call after the suspicion is cleared. The server(s) 204 may, based on the first API call being suspicious, send (908) a request for client device (e.g., the client 202A or 202B) to establish that the client device is authorized to make the first API call. The request may be included in an API response sent from the server(s) 204 to the client and may be a challenge as described above. For example, in the case of an out-of-band API call system (e.g., system 100A), the request/challenge from the server(s) 204 may be implemented as shown in the example API response below, labeled Table 2:

TABLE 2
444 Client Under Suspicion
HEADER
Challenge: call_resolver:bb82641f-dd1b-4da3-9582-1761ec4408e4

As shown above, the API response may include, for example, a “444 Client Under Suspicion” HTTP code and a “Challenge” header. In some implementations, the Challenge header may have a value format “Type:ID:Question:Timelimit.” The “type” may identify the type of challenge negotiated (e.g., during registration) between the client and the server(s) 204, and the “ID” may be an identifier (e.g., universally unique identifier (UUID)) for the instance of suspicion. The API response may, for example, include one or more questions the server(s) 204 may pose to client so that the client may prove it is authorized, and a time limit for the client to clear the suspicion. If the client does not clear the suspicion within the time limit, the suspicion may be confirmed. The client may receive the request/challenge in the API response and may resolve the suspicion/challenge if it is a legitimate client and has the challenge credentials (e.g., the second data indicated in the step 902). For example, in the case of an out-of-band resolution, the client may call a resolution endpoint (e.g., the resolver 110) with challenge credentials for that endpoint and pass the ID read from the Challenge header to the resolver (e.g., the resolver 110), and may also include a response to a question if present. A successful call to the resolver may clear or otherwise address the suspicion of the API call (e.g., in the data table), and return a notification to the client (e.g., HTTP code “200 OK”) that the suspicion has cleared or no longer exists. The call to the resolver to resolve the suspicion/challenge may be implemented as shown in the example call to the resolver below, labeled Table 3:

TABLE 3
POST /resolve
{“Id”: “bb826411-dd1b-4da3-9582-1761ec4408e4”}

In another example, in the case of an in-band API call system (e.g., system 100B), the request/challenge from the server(s) 204 may be implemented as shown in the example API response below, labeled Table 4:

TABLE 4

444 Client Under Suspicion
HEADER
Challenge: inband:xyz123:5 min

As shown above, the API response may include, for example, a “444 Client Under Suspicion” HTTP code and a “Challenge” header. In some implementations, the Challenge header may have a value format “Type:ID:Question:Timelimit.” The “type” may identify the type of challenge negotiated (e.g., during registration) between the client and the server(s), and the “ID” may be an identifier (e.g., universally unique identifier (UUID)) for the instance of suspicion. The API response may, for example, include one or more questions the server(s) 204 may pose to client so that the client may further prove it is authorized, and a time limit for the client to clear or otherwise address the suspicion. If the client does not clear the suspicion within the time limit, the suspicion may be confirmed.

The client may receive the request/challenge in the API response and may resolve the suspicion/challenge if it is a legitimate client and has the challenge credentials (e.g., the second data indicated in the step 902). For example, in the case of an in-band resolution, the client may sign the suspicion ID (e.g., “xyz123”) and/or a computed answer to one or more questions (if present) with a key (e.g., a pre-negotiated key), and include the signature in a Challenge-Response header which may be implemented as shown in the example API call retry sent to the server(s), labeled Table 5:

TABLE 5

HEADER
Challenge-Response: signed(xyz123)

The signature may be appended in the API call retry with an encrypted version of text or other data. When the server(s) 204 challenge the client on a suspicious API call, the challenge in the API response may have a new header (shown as “Challenge”). This may be an additional header appended to the API response from the server(s) 204 to the client. For example, once the client has made the necessary calculation to reply to the challenge, the additional header may be passed by the client to the server(s) 204 as part of the API call retry. The additional header may include both the question asked by the server(s) 204 and the signed value to indicate to the server(s) 204 that the client is in possession of the secret key or private key (e.g., the second data indicated in the step 902) to generate the signature.

The server(s) 204 may also receive (910) the response to the request. In the case of the out-of-band resolution, the response may be the call to the resolver (e.g., the resolver 110), which may be implemented as shown in Table 3 above. In the case of the in-band resolution, the response may be included in an additional header with the API call retry to the server(s) 204, which may be implemented as shown in Table 5 above.

The server(s) 204 may use the first data to determine (912) that the API response indicates that the client is in possession of the second data. Further, the server(s) 204 may determine (914) to process the first API call based on the API response indicating that the client is authorized to make the first API call. For example, the server(s) 204 may determine, using the first data, that the response was generated based on the second data, thus indicating that the client is authorized to make the first API call. As noted above, in some embodiments, prior to sending the request to the client (e.g., to establish that the client is authorized to make the first API call), the server(s) 204 may have determined (902) the first data to be used to determine whether the client possesses the second data. For example, the first data may be text in the Challenge, the response may be an encrypted version of the text, and the second data may be an encryption key provided to the client during the API registration. The server(s) 204 may also process (916) the first API call or a retry of the first API call (e.g., an API retry call), based on the response indicating that the client device is authorized to make the first API call, e.g., by using the first data to determine that the client device is in possession of the second data (and, e.g., the suspicion/challenge being cleared in the data table).

In some embodiments the server(s) 204 may determine, by a first component, that the response indicates that the client device is authorized to make the first API call, e.g., by using the first data to determine that the client device generated the response based at least in part on the second data. The first component may be the resolver (e.g., the resolver 110) running on the server(s) 204, the response may be included in the call to the resolver (e.g., as shown in Table 3), and the second data may be the challenge credentials. The server(s) 204 may process the first API call, e.g., as an API call retry, based on the resolver determining that the response was generated based on the second data (and, e.g., the suspicion/challenge being cleared in the data table).

After determining to process the first API call, the server(s) 204 may receive and process the retry of the first API call. For example, in the case of an out-of-band resolution, the API call retry may be the same as the original API call where the retry is attempted after the suspicion/challenge has been cleared or otherwise addressed. In the case of an in-band resolution, the API call retry may include the response to the challenge in the header of the API call retry. For example, after sending the request to the client, the server(s) 204 may receive the retry of the first API call from the client and determine that the retry of the first API call includes the response to the challenge, thus indicating that the client is authorized to make the first API call. The API server(s) 204A may configure the request/challenge to instruct the client to include the response in the retry of the first API call.

As discussed above, in some embodiments, the resolver (e.g., the resolver 110) may run on a computing system with a different URL endpoint than the API server(s) 204A. In such embodiments, the first API call may be received via a first URL endpoint (e.g., of the API server(s) 204A) and the response to the request/challenge may be received via a second URL endpoint (e.g., of the resolver 110). The API server(s) 204A may configure the request/challenge to instruct the client to send the response to the second URL endpoint. The API server(s) 204A may process the first API call, e.g., as an API call retry, based on the response to the request/challenge having been generated based on the second data. The response to the request/challenge may have been received by the API server(s) 204A from, for example, the resolver 110.

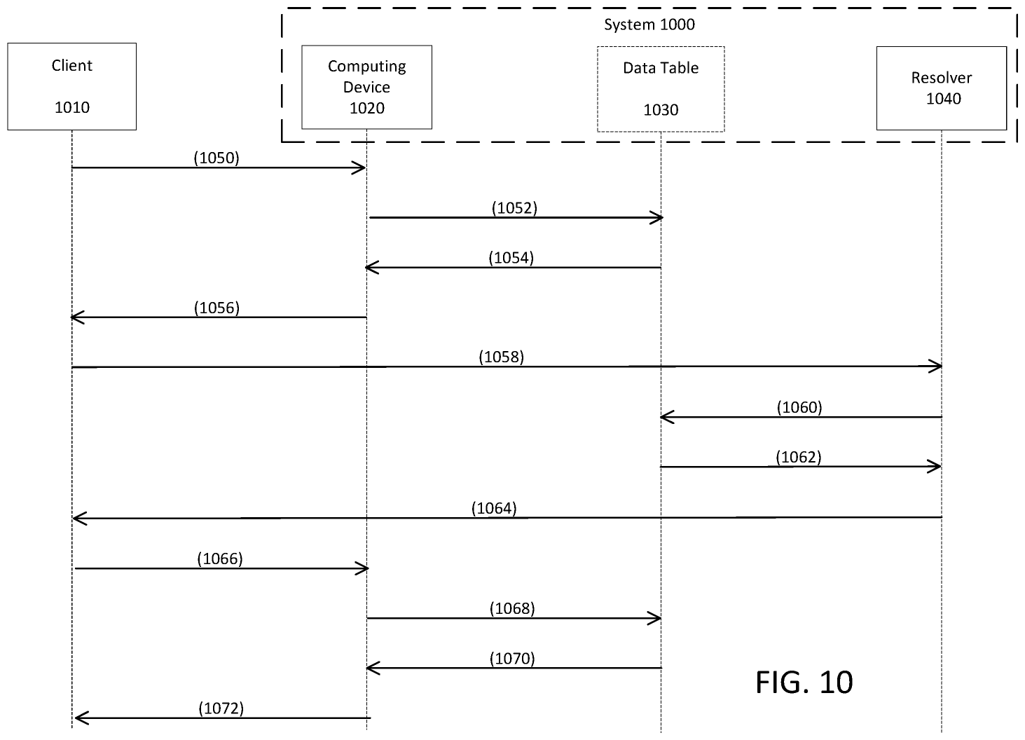

Referring now to FIG. 10, a sequence diagram illustrating an example workflow involving the example API call security system shown in FIG. 1A (e.g., out-of-band) is shown. The sequence diagram shows a client 1010 and a system 1000 that may include computing device (e.g., server(s)) 1020, a data table 1030, and a resolver 1040. The client 1010 may be similar to the client 202A of FIG. 1A. The system 1000 may be similar to the system 100A of FIG. 1A. The computing device 1020 may be similar to the API server(s) 204A of FIG. 1A. The data table 1030 may be similar to the data table 108A of FIG. 1A. The resolver 1040 may be similar to the resolver 110 of FIG. 1A. In some embodiments the data table 1030 and/or the resolver 1040 may be components running on the computing device 1020 and may be logistically part of the computing device 1020. Alternatively, in some embodiments the data table 1030 and/or the resolver 1040 may be components running on one or more other computing devices or servers.

As shown in the sequence diagram, the example workflow may begin with the computing device 1020 receiving (1050) an API call from the client 1010. The API call may be a legitimate API call including an anomaly or may be part of an unusual pattern of API calls. In other words, the API call may be suspicious. The computing device 1020 may send (1052) suspicion data related to the API call to the data table 1030 where it may be stored. Further, an analytics engine may be in communication with the computing device 1020 and the data table 1030 and may determine that the API call is suspicious based on the suspicion data and update the data table 1030 to indicate that the API call is suspicious. For example, the analytics engine may determine that the API call is suspicious by comparing prior data for API calls associated with the credentials presented, with data corresponding to the API call in question. The prior data may include, but is not limited to, locations from which the API calls originated, times of day at which the API calls were made, how often the client 1010 (or other devices) makes the API call, and devices from which the API calls originated. The data corresponding to the API call in question may include, but is not limited, to a location from which the API call originated, a time of the API call, a device from which the API call originated, and a number of failed attempts that may be associated with the API call. Further, the data table 1030 may indicate (1054) to the computing device1020 that the API call is suspicious or otherwise untrustworthy.

The computing device 1020 may send (1056) an API response to the client 1010. The response may include a Challenge header (e.g., as shown in Table 2) presenting a challenge to the client 1010. The client 1010 may send (1058) a call to the resolver 1040. The call may be implemented as shown in Table 3. The resolver 1040 may determine that the call includes a valid challenge credential and may send (1060) an indication to the data table 1030 to clear the suspicion of the API call. For example, the resolver 1040 may determine that a key, certificate, token, question and answer, username and password, etc., submitted with the API call corresponds to a challenge credential provided to the client 1010 (e.g., during registration with the API server(s)) making the API call. Further, the data table 1030 may send (1062) an indication to the resolver 1040 that the suspicion has been cleared or otherwise addressed. The resolver 1040 may send (1064) an indication to the client 1010 that the suspicion has been cleared or otherwise resolved (e.g., an HTTP code “200 OK”). The client 1010 may retry the API call and the server 1020 may receive (1066) an API call retry from the client 1010. The computing device 1020 may send (1068) a request for suspicion data related to the API call retry. The computing device 1020 may receive (1070) an indication from the data table 1030 that the API call retry is not suspicious or otherwise trustworthy. The computing device 1020 may send (1072) an indication to the client 1010 that the suspicion has been cleared (e.g., an HTTP code “200 OK”).

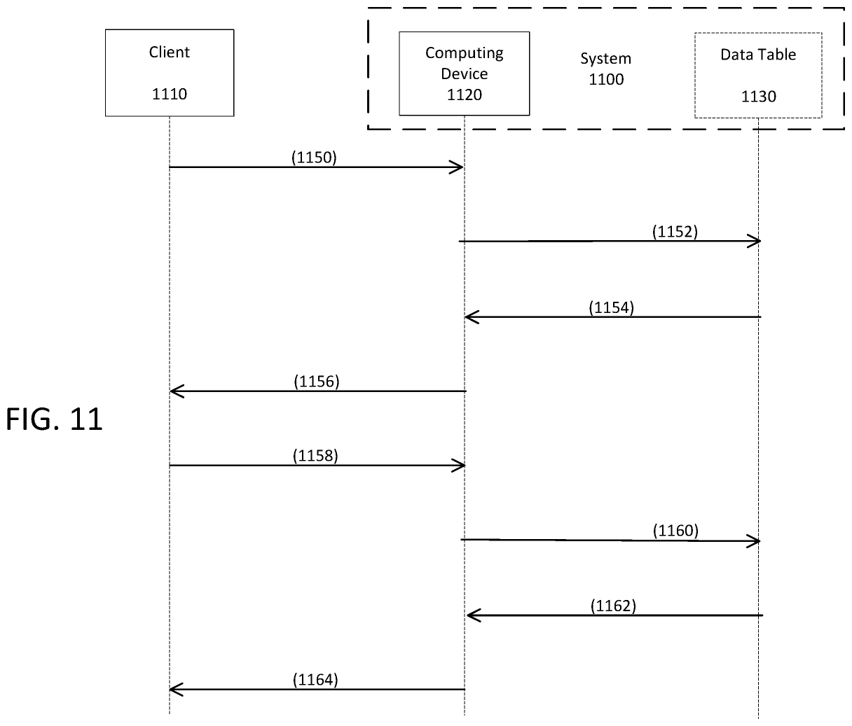

Referring now to FIG. 11, a sequence diagram illustrating an example workflow involving the example API call security system shown in FIG. 1B (e.g., in-band) is shown. The sequence diagram shows a client 1110 and a system 1100 that may include computing device (e.g., server(s)) 1120 and a data table 1130. The client 1110 may be similar to the client 202B of FIG. 1B. The system 1100 may be similar to the system 100B of FIG. 1B. The computing device 1120 may be similar to the API server(s) 204B of FIG. 1B. The data table 1130 may be similar to the data table 108B of FIG. 1B. In some embodiments the data table 1130 may be a component running on the computing device 1120 and may be logistically part of the computing device 1020. Alternatively, in some embodiments the data table 1130 may be a component running on one or more other computing devices or servers.

As shown in the sequence diagram, the example workflow may begin with the computing device 1120 receiving (1150) an API call from the client 1110. The API call may be a legitimate API call including an anomaly or may be part of an unusual pattern of API calls. In other words, the API call may be suspicious. The computing device 1120 may send (1152) suspicion data related to the API call to the data table 1130 where it may be stored. Further, an analytics engine may be in communication with the computing device 1120 and the data table 1130 and may determine that the API call is suspicious based on the data and update the data table 1130 to indicate that the API call is suspicious. For example, the analytics engine may determine that the API call is suspicious by comparing prior data for API calls associated with the credentials presented, with data corresponding to the API call in question. The prior data may include, but is not limited to, locations from which the API calls originated, times of day at which the API calls were made, how often the client 1110 (or other devices) makes the API call, and devices from which the API calls originated. The data corresponding to the API call in question may include, but is not limited to, a location from which the API call originated, a time of the API call, a device from which the API call originated, and a number of failed attempts that may be associated with the API call. Further, the data table 1130 may indicate (1154) to the server 1120 that the API call is suspicious.

The computing device 1120 may send (1156) an API response to the client 1010. The response may include a Challenge header (e.g. as shown in Table 4) presenting a challenge to the client 1110. The client 1110 may send (1158) an API call retry to the computing device 1120. The API call retry may be implemented as shown in Table 5. The computing device 1120 may determine that the API call retry includes a valid challenge credential and may send (1160) an indication to the data table 1130 to clear the suspicion of the API call. For example, the computing device 1120 may determine that a key, certificate, token, question and answer, username and password, etc., submitted with the API call retry corresponds to a challenge credential provided to the client 1110 (e.g., during registration with the API server(s)) making the API call. The data table 1130 may send (1162) an indication to the computing device 1120 that the suspicion has been cleared and may update the data table to indicate that the client 1010 and context of the API call that caused the suspicion are now trusted. The computing device 1120 may send (1164) an indication to the client 1110 that the suspicion has been cleared or otherwise addressed (e.g., an HTTP code “200 OK”).

As discussed above, multiple responses (e.g., pre-negotiated responses) for the purpose of challenging upon suspicion may be provided to the client during the registration, and the server(s) may indicate which response may be used to resolve a particular suspicion. In this way, layers of security may be added to the API call system. For example, the server(s) may determine whether an out-of-band or in-band challenge resolution should be used. The server(s) may pick and choose from the multiple responses for challenging based on the severity of the suspicion of the API call and different challenges may be issued to the client each time a suspicion occurs.

The techniques and features provided in the present disclosure may be implemented as a policy with an API gateway which may be reused across API providers. The API gateway implementation (e.g., via one or more server(s)) may require little if any modification for API call security as described herein and may be applied before an API call is deemed legitimate and passed to backend server(s) for processing. Thus, the API gateway may be a security layer in front of the API server(s). Such a capability may benefit API gateway vendors who may implement API call security in a generic and configurable manner.

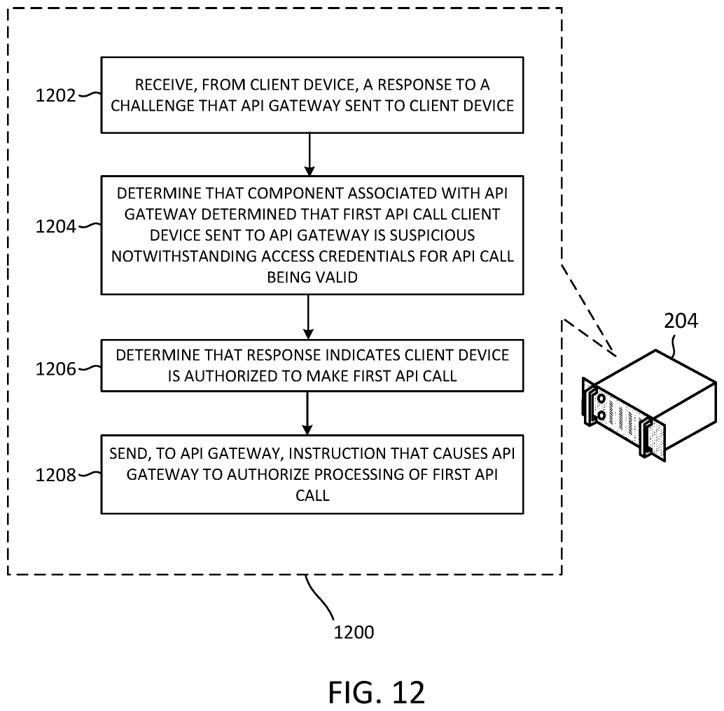

For example, one or more of the resolver 110, the analytics engine 106A, and the data table 108A may be implemented in a plug and play manner with existing API processing capability. Referring now to FIG. 12, an API call process 1200 involving example operations in accordance with some aspects of the present disclosure is shown. A computing system (e.g., one or more server(s) 204 running a resolver) may receive (1202), from a client device, a response to a challenge that an API gateway sent to the client device (e.g., after determining that a first API call the client device sent to the API gateway is suspicious). The computing system may be separate from the API gateway (e.g., one or more server(s) that handle API call traffic). The response may include a challenge credential provided to the client device during registration for use of the API. The computing system (e.g., via the resolver) may further determine (1204) that at least one component (e.g., the resolver 110 or the analytics engine 106A) associated with the API gateway determined that the first API call the client device sent to the API gateway is suspicious notwithstanding access credentials for the API call being valid

The computing system may also determine (1206) that the response indicates the client device is authorized to make the first API call. The computing system may also send (1208), to the API gateway, an instruction that causes the API gateway to authorize processing of the first API call. The computing system may, for example, configure the instruction to cause the API gateway to authorize processing of a retry of the first API call. Additionally, the computing system may store data indicating that the client device is authorized to make the first API call (e.g., as an API call retry). For example, the indication may cause updating of the data table to indicate such authorization.

It should be noted that the Challenge headers may be unique for different instances of suspicion so that they may not be reused on a subsequent challenge. Further, the suspicion resolution process or challenge mechanism may include an opt-in feature during client registration with the API so that clients may maintain control when security suspicions arise. The suspicion ID may be tagged to the original access credentials. For example, upon suspecting/challenging an API call employing a bearer token, credentials used to generate the bearer token may also be included in data table. This may cover situations where original access credentials are compromised and recreating a new bearer token upon being challenged may not clear the suspicion. Also, a flag (e.g., suspicion flag) or other indicator may be set up in a lookup store which is queried for every API call, or could be inserted into the API context as a header by an API traffic pre-processing layer.

The description above regarding the API gateway and the resolver may be directed towards an out-of-band challenge resolution. For an in-band challenge resolution, the API call retry (e.g., with a challenge response from a client) may be received by the API gateway and the API gateway may validate the possession of second data by the client, clear the suspicion, and allow the API call to be processed.

While examples have been provided in the present disclosure to illustrate how the advantages of the techniques and features provided may be realized, these examples have been provided for illustrative purposes only and are not intended to limit the scope of the claims below.

F. Example Implementations of Methods, Systems, and Computer-Readable Media in Accordance with the Present Disclosure

The following paragraphs (M1) through (M11) describe examples of methods that may be implemented in accordance with the present disclosure.

(M1) A method may be performed that involves determining, by a computing system, that first access credentials for a first API call received from a client device are valid; initially refraining from processing the first API call, notwithstanding the first access credentials being valid, based at least in part on the computing system determining that the first API call is suspicious; sending, from the computing system to the client device and based at least in part on the first API call being suspicious, a request for the client device to establish that the client device is authorized to make the first API call; receiving, by the computing system and from the client device, a response to the request; and determining, by the computing system, to process the first API call based at least in part on the response indicating that the client device is authorized to make the first API call.

(M2) A method may be performed as described in paragraph (M1), and may further involve prior to sending the request to the client device, determining, by the computing system, first data that is to be used to determine whether the client device possesses second data; and using, by the computing system, the first data to determine that the response indicates that the client device is in possession of the second data.

(M3) A method may be performed as described in paragraph (M1) or paragraph (M2), and may further involve processing, by the computing system, a retry of the first API call based at least in part on the response indicating that the client device is in possession of the second data.

(M4) A method may be performed as described any of paragraphs (M1) through (M3), and may further involve. prior to sending the request to the client device, sending, by the computing system to the client device, the second data.

(M5) A method may be performed as described any of paragraphs (M1) through (M4), and may further involve after determining to process the first API call, receiving, by the computing system, a retry of the first API call; and processing, by the computing system, the retry of the first API call.

(M6) A method may be performed as described any of paragraphs (M1) through (M5), and may further involve after sending the request to the client device, receiving, by the computing system and from the client device, a retry of the first API call; and determining, by the computing system, that the retry of the first API call includes the response indicating that the client device is authorized to make the first API call.

(M7) A method may be performed as described any of paragraphs (M1) through (M6), and may further involve receiving the first API call via a first endpoint; and receiving the response to the request via a second endpoint.

(M8) A method may be performed as described any of paragraphs (M1) through (M7), and may further involve configuring the request to instruct the client device to send the response to the second endpoint.

(M9) A method may be performed as described any of paragraphs (M1) through (M8), and may further involve configuring the request to instruct the client device to include the response in a retry of the first API call.

(M10) A method may be performed that involves receiving, by a computing system and from a client device, a response to a challenge that an API gateway sent to the client device; determining, by the computing system, that at least one component associated with the API gateway determined that a first API call the client device sent to the API gateway is suspicious notwithstanding access credentials for the API call being valid; determining, by the computing system, that the response indicates the client device is authorized to make the first API call; and sending, by the computing system to the API gateway, an instruction that causes the API gateway to authorize processing of the first API call.

(M11) A method may be performed as described in paragraph (M10), and may further involve configuring the instruction to cause the API gateway to authorize processing of a retry of the first API call.

The following paragraphs (S1) through (S11) describe examples of systems and devices that may be implemented in accordance with the present disclosure.

(S1) A system may comprise at least one processor and at least one computer-readable medium encoded with instructions which, when executed by the at least one processor, cause the system to determine that first access credentials for a first API call received from a client device are valid, initially refrain from processing the first API call, notwithstanding the first access credentials being valid, based at least in part on determining that the first API call is suspicious, send, to the client device and based at least in part on the first API call being suspicious, a request for the client device to establish that the client device is authorized to make the first API call, receive, from the client device, a response to the request, and determine to process the first API call based at least in part on the response indicating that the client device is authorized to make the first API call.

(S2) A system may be configured as described in paragraph (S1), wherein the at least one computer-readable medium may be encoded with additional instructions which, when executed by the at least one processor, further cause the system to prior to sending the request to the client device, determine first data that is to be used to determine whether the client device possesses second data; and use the first data to determine that the response indicates that the client device is in possession of the second data.

(S3) A system may be configured as described in paragraph (S1) or paragraph (S2), wherein the at least one computer-readable medium may be encoded with additional instructions which, when executed by the at least one processor, further cause the system to process a retry of the first API call based at least in part on the response indicating that the client device is in possession of the second data.

(S4) A system may be configured as described in any of paragraph (S1) through (S3), wherein the at least one computer-readable medium may be encoded with additional instructions which, when executed by the at least one processor, further cause the system to prior to sending the request to the client device, send the second data to the client device.

(S5) A system may be configured as described in any of paragraph (S1) through (S4), wherein the at least one computer-readable medium may be encoded with additional instructions which, when executed by the at least one processor, further cause the system to after determining to process the first API call, receive a retry of the first API call; and process the retry of the first API call.

(S6) A system may be configured as described in any of paragraph (S1) through (S5), wherein the at least one computer-readable medium may be encoded with additional instructions which, when executed by the at least one processor, further cause the system to after sending the request to the client device, receive a retry of the first API call from the client device; and determine that the retry of the first API call includes the response indicating that the client device is authorized to make the first API call.

(S7) A system may be configured as described in any of paragraph (S1) through (S6), wherein the at least one computer-readable medium may be encoded with additional instructions which, when executed by the at least one processor, further cause the system to receive the first API call via a first endpoint; and receive the response to the request via a second endpoint.

(S8) A system may be configured as described in any of paragraph (S1) through (S7), wherein the at least one computer-readable medium may be encoded with additional instructions which, when executed by the at least one processor, further cause the system to configure the request to instruct the client device to send the response to the second endpoint.

(S9) A system may be configured as described in any of paragraph (S1) through (S8), wherein the at least one computer-readable medium may be encoded with additional instructions which, when executed by the at least one processor, further cause the system to configure the request to instruct the client device to include the response in a retry of the first API call.

(S10) A system may comprise at least one processor and at least one computer-readable medium encoded with instructions which, when executed by the at least one processor, cause the system to receive, from a client device, a response to a challenge that an application programming interface (API) gateway sent to the client device; determine that at least one component associated with the API gateway determined that a first API call the client device sent to the API gateway is suspicious notwithstanding access credentials for the API call being valid; determine that the response indicates the client device is authorized to make the first API call; and send to the API gateway, an instruction that causes the API gateway to authorize processing of the first API call.

(S11) A system may be configured as described in paragraph (S10), wherein the at least one computer-readable medium may be encoded with additional instructions which, when executed by the at least one processor, further cause the system to configure the instruction to cause the API gateway to authorize processing of a retry of the first API call.

The following paragraphs (CRM1) through (CRM11) describe examples of computer-readable media that may be implemented in accordance with the present disclosure.

(CRM1) At least one non-transitory, computer-readable medium may be encoded with instructions which, when executed by at least one processor included in a computing system, cause the computing system to determine that first access credentials for a first API call received from a client device are valid, initially refrain from processing the first API call, notwithstanding the first access credentials being valid, based at least in part on determining that the first API call is suspicious, send, to the client device and based at least in part on the first API call being suspicious, a request for the client device to establish that the client device is authorized to make the first API call, receive, from the client device, a response to the request, and determine to process the first API call based at least in part on the response indicating that the client device is authorized to make the first API call.

(CRM2) At least one non-transitory, computer-readable medium may be configured as described in paragraph (CRM1), and may be encoded with additional instructions which, when executed by the at least one processor, further cause the computing system to prior to sending the request to the client device, determine first data that is to be used to determine whether the client device possesses second data; and use the first data to determine that the response indicates that the client device is in possession of the second data.

(CRM3) At least one non-transitory, computer-readable medium may be configured as described in paragraph (CRM1) or paragraph (CRM2), and may be encoded with additional instructions which, when executed by the at least one processor, further cause the computing system to process a retry of the first API call based at least in part on the response indicating that the client device is in possession of the second data.

(CRM4) At least one non-transitory, computer-readable medium may be configured as described in any of paragraphs (CRM1) through (CRM3), and may be encoded with additional instructions which, when executed by the at least one processor, further cause the computing system to prior to sending the request to the client device, send the second data to the client device.

(CRM4) At least one non-transitory, computer-readable medium may be configured as described in any of paragraphs (CRM1) through (CRM3), and may be encoded with additional instructions which, when executed by the at least one processor, further cause the computing system to prior to sending the request to the client device, send the second data to the client device.

(CRM5) At least one non-transitory, computer-readable medium may be configured as described in any of paragraphs (CRM1) through (CRM4), and may be encoded with additional instructions which, when executed by the at least one processor, further cause the computing system to after determining to process the first API call, receive a retry of the first API call; and process the retry of the first API call.

(CRM6) At least one non-transitory, computer-readable medium may be configured as described in any of paragraphs (CRM1) through (CRM5), and may be encoded with additional instructions which, when executed by the at least one processor, further cause the computing system to after sending the request to the client device, receive a retry of the first API call from the client device; and determine that the retry of the first API call includes the response indicating that the client device is authorized to make the first API call.

(CRM7) At least one non-transitory, computer-readable medium may be configured as described in any of paragraphs (CRM1) through (CRM6), and may be encoded with additional instructions which, when executed by the at least one processor, further cause the computing system to receive the first API call via a first endpoint; and receive the response to the request via a second endpoint.

(CRM8) At least one non-transitory, computer-readable medium may be configured as described in any of paragraphs (CRM1) through (CRM7), and may be encoded with additional instructions which, when executed by the at least one processor, further cause the computing system to configure the request to instruct the client device to send the response to the second endpoint.

(CRM9) At least one non-transitory, computer-readable medium may be configured as described in any of paragraphs (CRM1) through (CRM8), and may be encoded with additional instructions which, when executed by the at least one processor, further cause the computing system to configure the request to instruct the client device to include the response in a retry of the first API call.

(CRM10) At least one non-transitory, computer-readable medium may be encoded with instructions which, when executed by at least one processor included in a computing system, cause the computing system to receive, from a client device, a response to a challenge that an API gateway sent to the client device; determine that at least one component associated with the API gateway determined that a first API call the client device sent to the API gateway is suspicious notwithstanding access credentials for the API call being valid; determine that the response indicates the client device is authorized to make the first API call; and send to the API gateway, an instruction that causes the API gateway to authorize processing of the first API call.

(CRM11) At least one non-transitory, computer-readable medium may be configured as described in paragraph (CRM10), and may be encoded with additional instructions which, when executed by the at least one processor, further cause the computing system to configure the instruction to cause the API gateway to authorize processing of a retry of the first API call.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
determining, by a computing system, that a first access credential for a first application programming interface (API) call received from a client device is valid;
initially refraining from processing the first API call, notwithstanding the first access credential being valid, based at least in part on the computing system determining that the first API call is suspicious;
sending, from the computing system to the client device and based at least in part on the first API call being suspicious, a request for the client device to send a challenge response to the computing system;
receiving, by the computing system and from the client device, the challenge response;
determining, by the computing system and based at least in part on the challenge response and first data that was stored by the computing system before the client device sent the first API call to the computing system, that second data was stored in a storage medium accessible to the client device before the client device sent the first API call to the computing system; and
determining, by the computing system, to process the first API call based at least in part the second data having been stored in the storage medium before the client device sent the first API call to the computing system.

2. (canceled)

3. The method of claim 1, further comprising:
processing, by the computing system, a retry of the first API call based at least in part on the second data having been stored in the storage medium before the client device sent the first API call to the computing system.

4. The method of claim 1, further comprising:
prior to receiving the first API call from the client device, sending, from the computing system to the client device, the second data.

5. The method of claim 1, further comprising:
after determining to process the first API call, receiving, by the computing system, a retry of the first API call; and
processing, by the computing system, the retry of the first API call.

6. The method of claim 1, further comprising:
after sending the request to the client device, receiving, by the computing system and from the client device, a retry of the first API call; and
determining, by the computing system, that the retry of the first API call includes the challenge response.

7. The method of claim 1, further comprising:
receiving the first API call via a first endpoint; and
receiving the challenge response via a second endpoint.

8. The method of claim 7, further comprising:
configuring the request to instruct the client device to send the challenge response to the second endpoint.

9. The method of claim 1, further comprising:
configuring the request to instruct the client device to include the challenge response in a retry of the first API call.

10. A computing system, comprising:
at least one processor; and
at least one non-transitory computer-readable medium encoded with instructions which, when executed by the at least one processor, cause the computing system to:
determine that a first access credential for a first application programming interface (API) call received from a client device [[are]] is valid,
initially refrain from processing the first API call, notwithstanding the first access credential being valid, based at least in part on determining that the first API call is suspicious,
send, to the client device and based at least in part on the first API call being suspicious, a request for the client device to send a challenge response to the computing system,
receive, from the client device, [[a]] the challenge response,
determine, based at least in part on the challenge response and first data that was stored by the computing system before the client device sent the first API call to the computing system, that second data was stored in a storage medium accessible to the client device before the client device sent the first API call to the computing system, and
determine to process the first API call based at least in part on the second data having been stored in the storage medium before the client device sent the first API call to the computing system.

11. (canceled)

12. The computing system of claim 10, wherein the at least one non-transitory computer-readable medium is further encoded with additional instructions which, when executed by the at least one processor, further cause the computing system to:
process a retry of the first API call based at least in part on the second data having been stored in the storage medium before the client device sent the first API call to the computing system.

13. The computing system of claim 10, wherein the at least one non-transitory computer-readable medium is further encoded with additional instructions which, when executed by the at least one processor, further cause the computing system to:
prior to receiving the first API call from, send the second data to the client device.

14. The computing system of claim 10, wherein the at least one non-transitory computer-readable medium is further encoded with additional instructions which, when executed by the at least one processor, further cause the system to:
after determining to process the first API call, receive a retry of the first API call; and
process the retry of the first API call.

15. The computing system of claim 10, wherein the at least one non-transitory computer-readable medium is further encoded with additional instructions which, when executed by the at least one processor, further cause the computing system to:
after sending the request to the client device, receive a retry of the first API call from the client device; and
determine that the retry of the first API call includes the challenge response.

16. The computing system of claim 10, wherein the at least one non-transitory computer-readable medium is further encoded with additional instructions which, when executed by the at least one processor, further cause the computing system to:
receive the first API call via a first endpoint; and
receive the challenge response via a second endpoint.

17. The computing system of claim 16, wherein the at least one non-transitory computer-readable medium is further encoded with additional instructions which, when executed by the at least one processor, further cause the computing system to:
configure the request to instruct the client device to send the challenge response to the second endpoint.

18. The computing system of claim 10, wherein the at least one non-transitory computer-readable medium is further encoded with additional instructions which, when executed by the at least one processor, further cause the computing system to:
configure the request to instruct the client device to include the challenge response in a retry of the first API call.

19. A method, comprising:
determining, by a computing system, that at least one component associated with an application programming interface (API) gateway determined that a first API call a client device sent to the API gateway is suspicious notwithstanding an access credential for the API call being valid;
receiving, by the computing system and from the client device, a response to a challenge that the API gateway sent to the client device;
determining, by the computing system and based at least in part on the response and first data that was stored by the computing system before the client device sent the first API call to the API gateway, that second data was stored in a storage medium accessible to the client device before the client device sent the first API call to the API gateway; and
sending, from the computing system to the API gateway and based at least in part on the second data having been stored in the storage medium before the client device sent the first API call to the API gateway, an instruction that causes the API gateway to authorize processing of the first API call.

20. The method of claim 19, further comprising:
configuring the instruction to cause the API gateway to authorize processing of a retry of the first API call.

21. The method of claim 19, further comprising:
prior to the API gateway receiving the first API call from the client device, sending, from the computing system to the client device, the second data.

22. The method of claim 19, further comprising:
configuring the challenge to instruct the client device to send the response to a first endpoint which is different than a first endpoint of the API gateway.
